(19) United States
(12) Patent Application Publication
(10) Pub. No.: US 2014/0164728 A1
(43) Pub. Date: Jun. 12, 2014

(54) METHOD FOR ALLOCATING AND REALLOCATING LOGICAL VOLUME

(71) Applicant: HITACHI, LTD., Tokyo (JP)

(72) Inventors: Katsumi Ouchi, Tokyo (JP); Hajime Mori, Tokyo (JP)

(21) Appl. No.: 13/981,822

(22) PCT Filed: Dec. 6, 2012
(86) PCT No.: PCT/JP2012/081655

§ 371 Date: Jul. 25, 2013

(51) Int. Cl. G06F 12/02

(52) U.S. Cl. CPC G06F 12/02
USPC 711/170

(57) ABSTRACT

If multiple drive chassis, in a storage system, the inlet air temperature or operation amount differs greatly among the drive chassis, total fan power in the drive chassis and may increase greatly, causing noise increase depending on operation amount and inlet air temperature compared to where there is little difference in inlet air temperature and the distribution of the operation amount. Thus, in such a storage system including one or more drive units and one or more cooling fans, a first order of priority is set to a logical volume having the largest amount of power increase by the operation of the logical volume. A second order of priority is set to a drive chassis having the smallest power increase amount of the cooling fan. Reallocation is performed from the logical volume having the first order of priority to the drive chassis having the second order of priority.

### TECHNICAL FIELD

The present invention relates to a method for allocating and reallocating logical volumes within a storage system, mainly with the aim to cut down power consumption.

### BACKGROUND ART

Recently, the amount of information that companies and the like retain is increasing at an explosive pace, and the number of storage systems such as disk arrays for storing the information in data centers is also increased. Therefore, administrators of information systems in companies are required to manage a large number of storage systems. In response, there are active moves to aggregate the large number of storage systems into a large scale storage system. However, when operating a large-scale storage system, the increase of power consumption and the increase of heat generation in the storage system becomes a problem. As a result, the discharged amount of carbon dioxide is increased, and global warming has become a serious issue.

Patent document 1 discloses a storage system configuration adopting a technique to change the rotation speed of fans included in the storage system in order to cool the storage system.

Patent document 2 discloses an art to optimize the power of air conditioners for cooling storage systems from the exterior. The method calculates plural combinations of allocating to storage systems logical volumes which are virtual (or logical) storage devices for providing storage areas included in the storage systems to a host computer, calculating the amount of heat generation of the storage systems based on the operation amount of the logical volume, and calculating the power of the air conditioners required for cooling the storage systems. At this time, the method selects a combination of logical volumes for optimizing the power of the air conditioners, and moves the data stored in the logical volumes of the storage systems.

### CITATION LIST

### Patent Literature

### [PTL 1]

Japanese Patent Application Laid-Open Publication No. 2000-149542

### [PTL 2]

Japanese Patent Application Laid-Open Publication No. 2010-108115

(United States Patent Application Publication No. U.S.2010/0106988)

### SUMMARY OF INVENTION

### Technical Problem

Along with the increase of capacity and speed of the drive units mounted in storage systems, not only the power of the drive units but also the power of the cooling devices (such as cooling fans) required to cool the drive units are increased. Therefore, when considering the reduction of power consumption of a storage system, it is also necessary to consider the power consumption of fans.

In general, the power consumption of cooling fans increases in proportion to a triplicate of the rotation speed. Therefore, the power required by the rotation of the cooling fans varies greatly according to the environment temperature or the operation amount within the chassis.

In a data center, a temperature difference of about 10° C. occurs among the inlet air temperatures even along a same cold aisle, depending on the distance from the air conditioner outlet. As described, since the fan power is proportional to the triplicate of rotation speed, if the storage systems are used in an environment where the inlet air temperatures or the operation amount distribution differ greatly among drive chassis, the fan power may differ greatly among the multiple drive chassis and the noise caused thereby may be increased depending on the combination of operation status and environment temperature.

However, patent document 1 lacks to consider optimizing the power of the cooling fans that are disposed in the chassis of the storage system.

Further, patent document 2 lacks to disclose any technique related to optimizing the power consumption of cooling fans disposed in multiple chassis.

### Solution to Problem

In a storage system comprising multiple drive chassis having one or more drive units and one or more cooling fans in which all or a portion of a storage area included in the drive unit is set as a logical volume, the amount of power increase of the cooling fans by the operation of the logical volumes is computed, and a drive chassis as an allocation destination of the logical volume is selected with higher priority in the order from those having the smallest amount of computed power increase, based on which the logical volume is allocated to the selected drive chassis.

### [Advantageous Effects of Invention]

According to the present invention, it becomes possible to suppress the increase of power consumption and the increase of noise caused by the rotation of the cooling fans in the drive chassis, even if the inlet air temperature distribution or the operation amount of logical volumes varies among multiple drive chassis constituting the storage system.

### BRIEF DESCRIPTION OF DRAWINGS

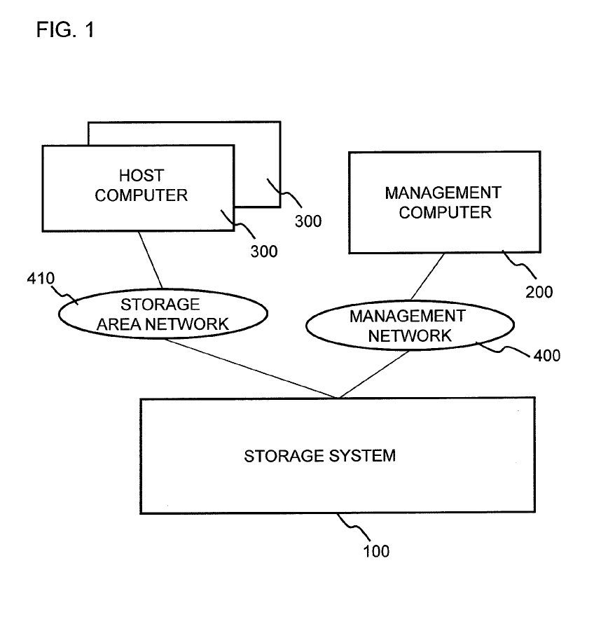

### [FIG. 1]

FIG. 1 is a view showing a system configuration according to a preferred embodiment of the present invention.

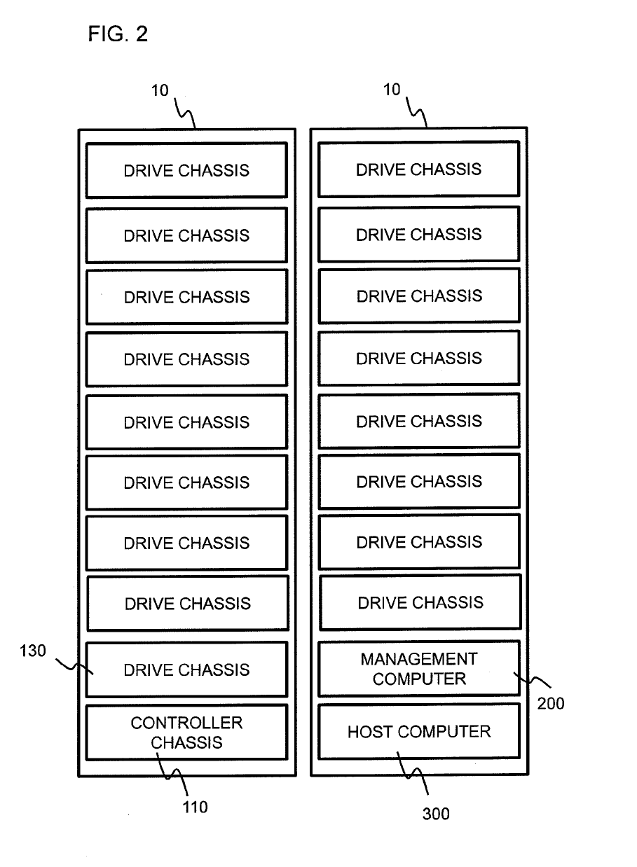

### [FIG. 2]

FIG. 2 is a view showing an arrangement of chassis within a rack 10 according to the preferred embodiment of the present invention.

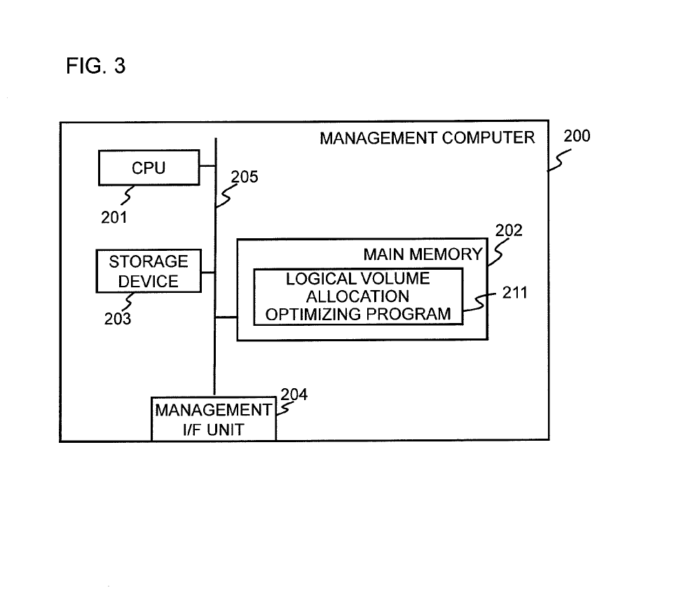

### [FIG. 3]

FIG. 3 is a view showing a configuration of a management computer 200 according to the preferred embodiment of the present invention.

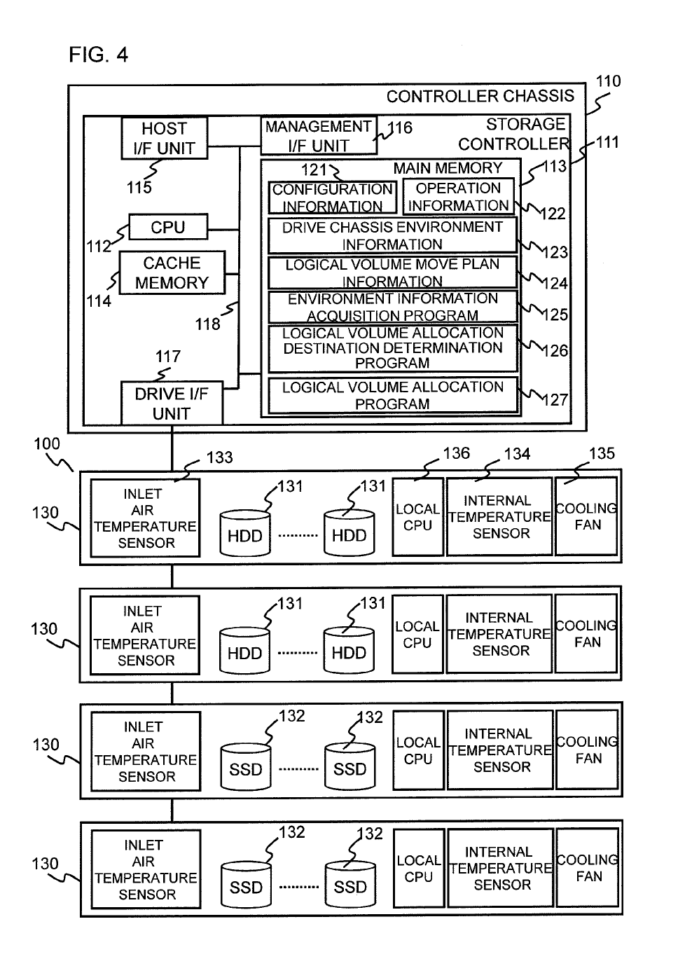

### [FIG. 4]

FIG. 4 is a view showing a configuration of a storage system 100 according to the preferred embodiment of the present invention.

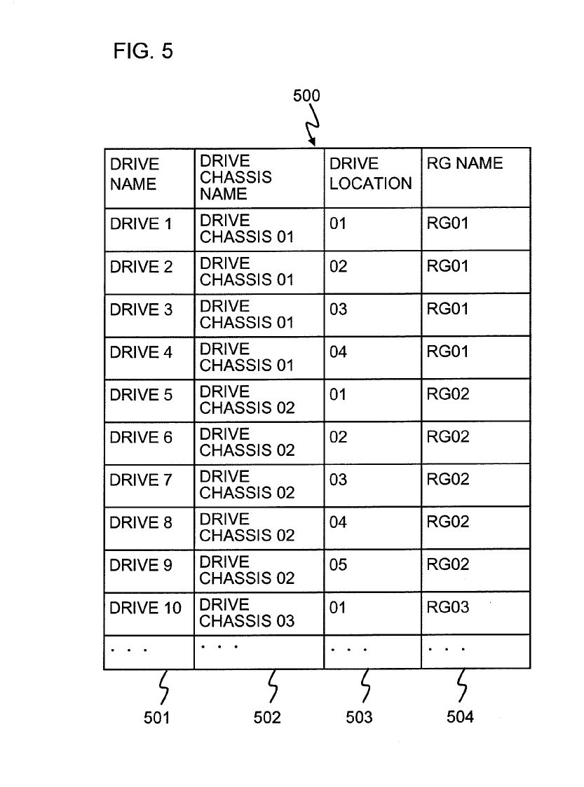

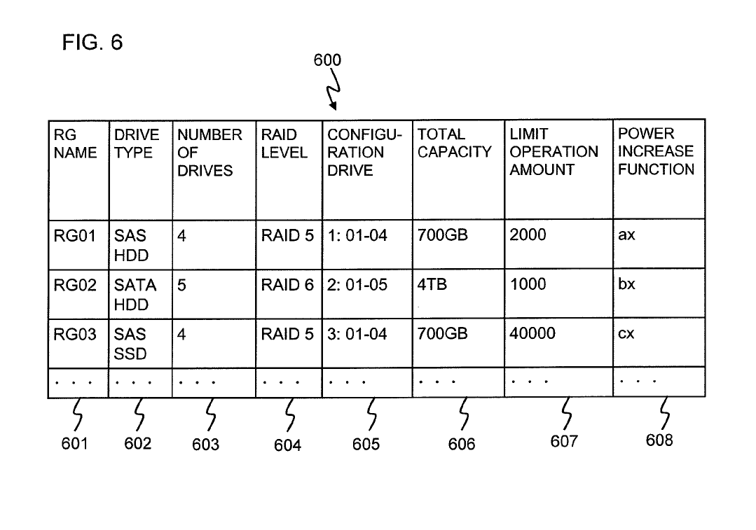

### [FIG. 5]

FIG. 5 is a view showing a drive configuration management table 500 according to the preferred embodiment of the present invention.

### [FIG. 6]

FIG. 6 is a view showing an RG configuration management table 600 according to the preferred embodiment of the present invention.

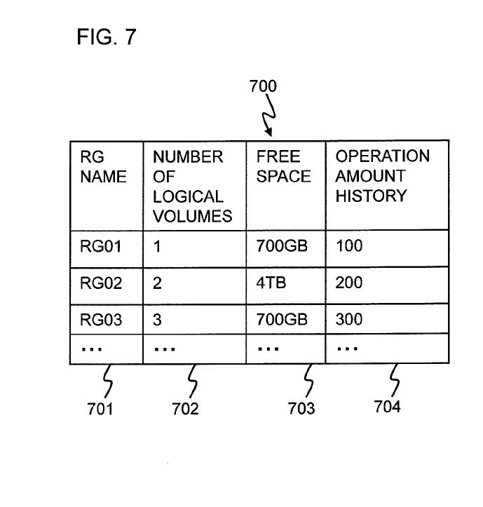

### [FIG. 7]

FIG. 7 is a view showing an RG operation management table 700 according to the preferred embodiment of the present invention.

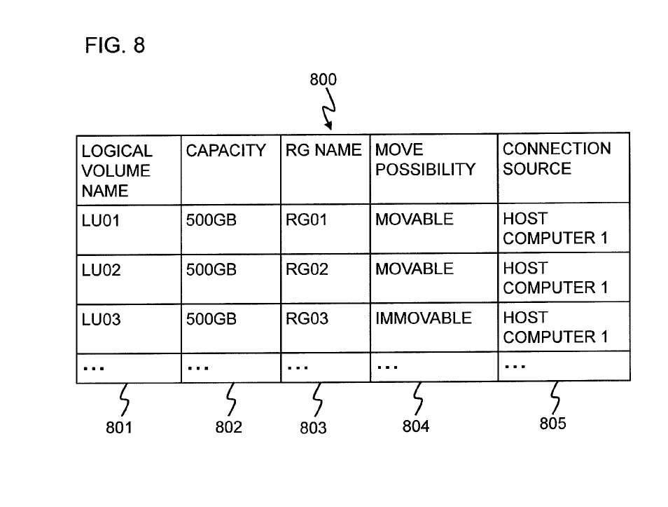

### [FIG. 8]

FIG. 8 is a view showing a logical volume configuration management table 800 according to the preferred embodiment of the present invention.

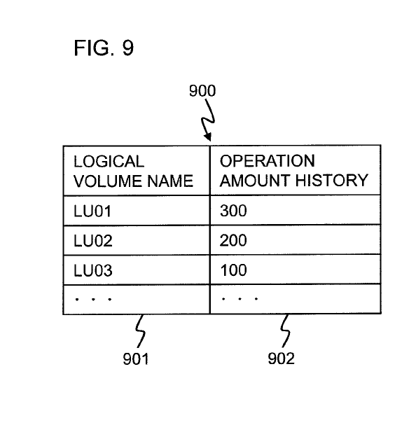

### [FIG. 9]

FIG. 9 is a view showing a logical volume operation management table 900 according to the preferred embodiment of the present invention.

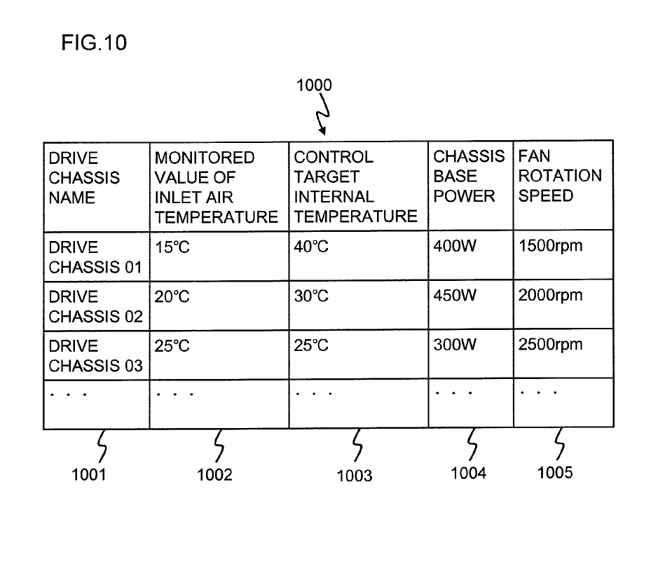

### [FIG. 10]

FIG. 10 is a view showing a drive chassis environment management table 1000 according to the preferred embodiment of the present invention.

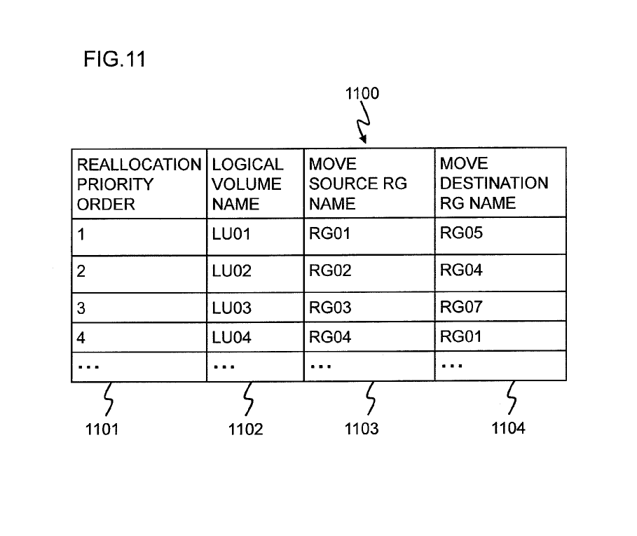

### [FIG. 11]

FIG. 11 is a view showing a logical volume move plan table 1100 according to the preferred embodiment of the present invention.

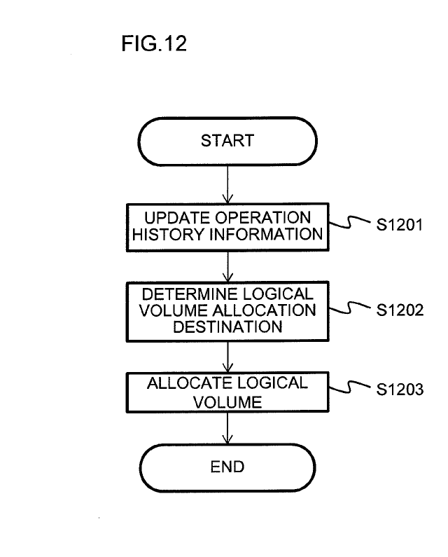

### [FIG. 12]

FIG. 12 is a view showing an overall process flow of the process for determining a logical volume allocation according to the preferred embodiment of the present invention.

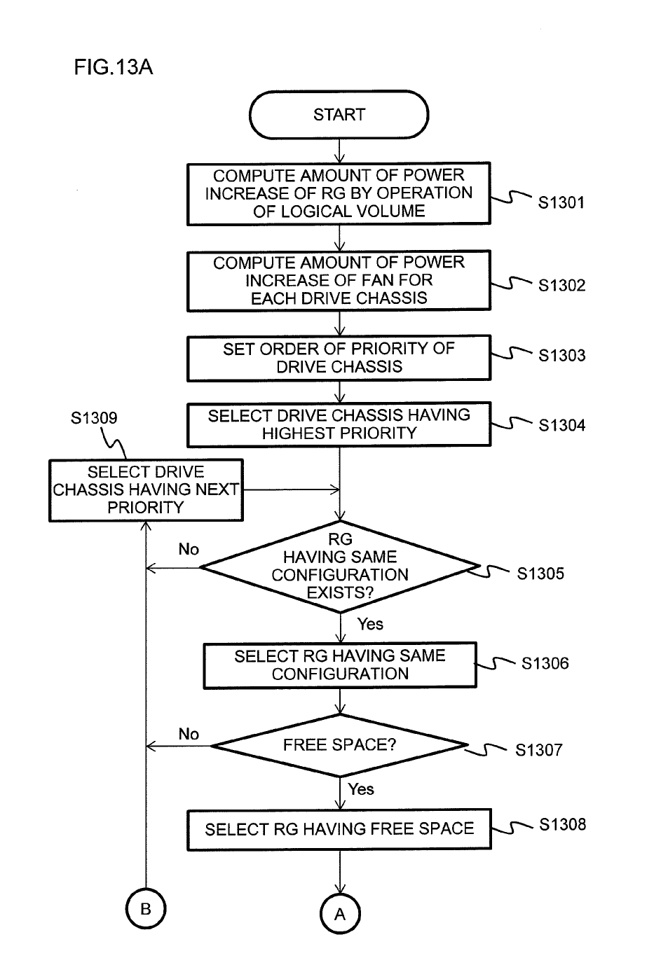

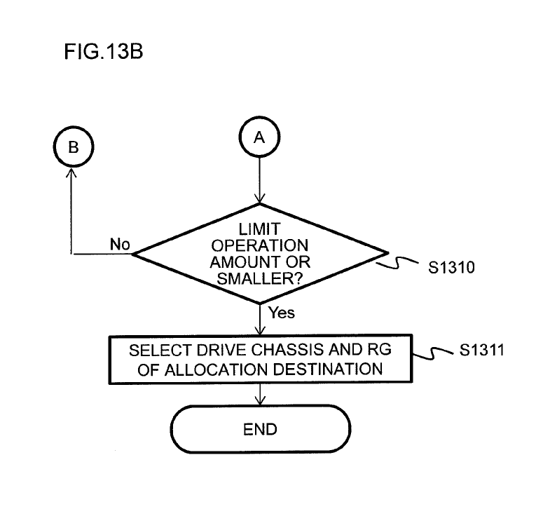

### [FIG. 13A]

FIG. 13A is a view showing a portion (former ham of the process flow for determining a new allocation destination of a logical volume according to embodiments 1 and 2.

### [FIG. 13B]

FIG. 13B is a view showing a portion (latter half) of the process flow for determining a new allocation destination of a logical volume according to embodiments 1 and 2.

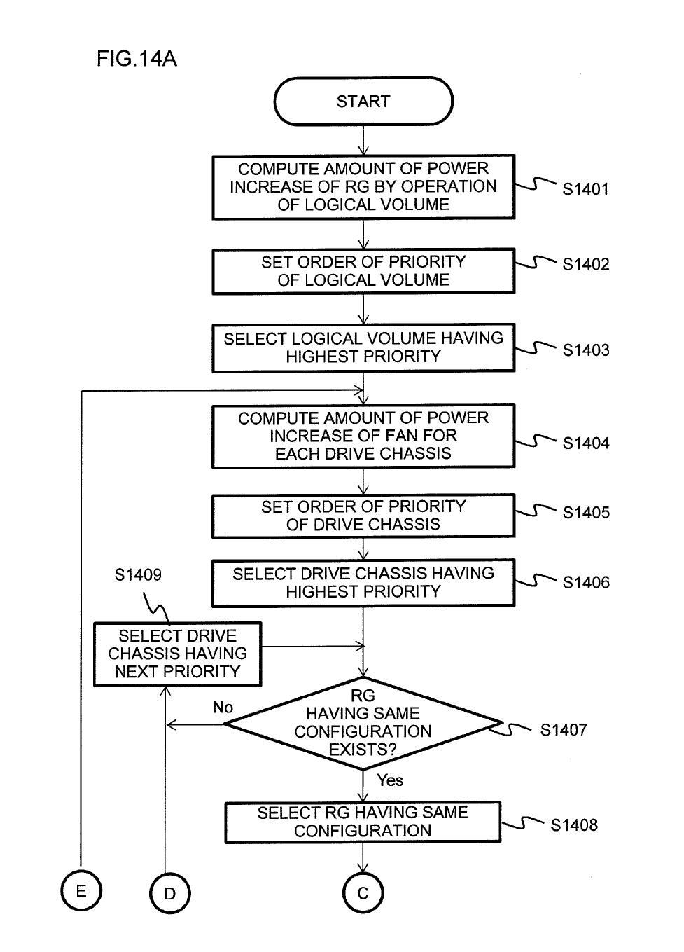

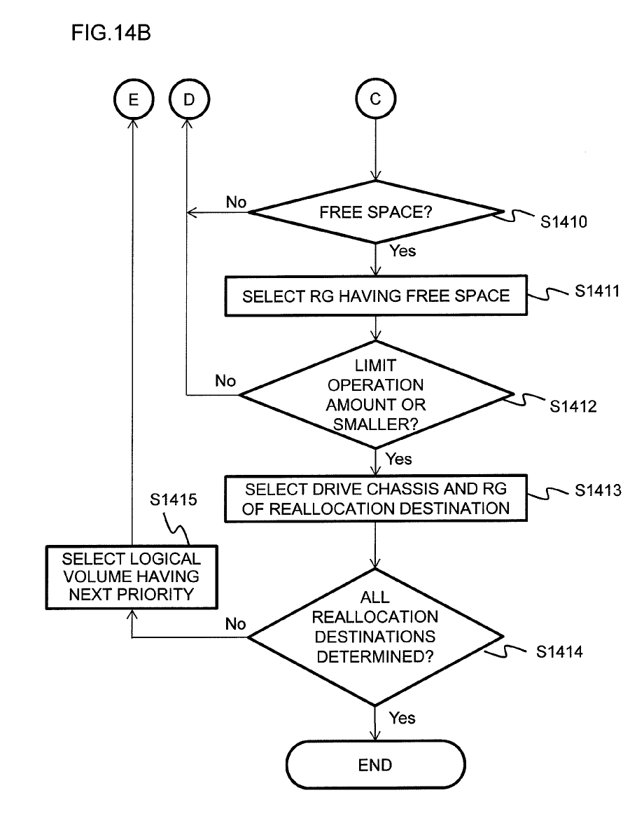

### [FIG. 14A]

FIG. 14A is a view showing a portion (former half) of the process flow for determining a reallocation destination of a logical volume according to embodiment 3.

### [FIG. 14B]

FIG. 14B is a view showing a portion (latter half) of the process flow for determining a reallocation destination of a logical volume according to embodiment 3.

### DESCRIPTION OF EMBODIMENTS

Now, the preferred embodiments of the present invention will be described with reference to the drawings.

### Embodiment 1

### <New Allocation of Logical Volume>

In embodiment 1, when a logical volume is initially allocated to a storage system having a plurality of drive chassis and no logical volume allocated thereto, the amount of increase in fan power of the drive chassis by allocating the logical volume to the drive chassis is computed, and the logical volume is allocated by selecting the drive chassis as the allocation destination of the logical volume, so that the amount of increase in fan power of the overall storage system is minimized.

FIG. 1 is a view showing a system configuration according to a preferred embodiment of the present invention.

The present system is composed of a storage system 100, a storage area network 410, a management network 400, a host computer 300, and a management computer 200.

The host computer 300 is coupled to the storage system 100 via the storage area network 410. The storage area network 410 is, for example, a fibre channel. The storage area network 410 is used, for example, by the host computer 300 to read the information necessary for performing a computing process from the storage system 100 and to write data into the storage system 100.

The management computer 200 is coupled to the storage system 100 via a management network 400. The management network 400 can be, for example, the Ethernet (Registered Trademark). The management network 400 is used by the management computer 200 for managing the storage system 100. For example, the management computer 200 can acquire various types of information from the storage system 100 via the management network 400.

The respective chassis of the storage system 100, the chassis of the host computer 300 and the chassis of the management computer 200 constituting the present system are mounted on a rack 10, and the front side of the rack 10 corresponding to an air inlet side of the respective chassis is arranged on a cold aisle (cool air side) within a data center.

FIG. 2 illustrates an example of an arrangement plan in which the racks 10 according to the preferred embodiment of the present invention are observed from the front side.

As shown in FIG. 2, on one of the racks 10 are disposed, from the bottom, a controller chassis 110 of the storage system 100 (one chassis), and drive chassis 130 of the storage system 100 (nine chassis). On the other rack 10 are disposed, from the bottom, a host computer 300 (one chassis), a management computer 200 (one chassis), and drive chassis 130 of the storage system 100 (eight chassis).

However, the number and area of allocation of the controller chassis 110 and drive chassis 130 of the storage system 100, the number and area of allocation of the host computer 300, and the area of allocation of the management computer 200 mounted on each rack 10 are not restricted to the illustrated example.

FIG. 3 is a view showing in detail one example of the configuration of the management computer 200 illustrated in FIG. 1 according to the preferred embodiment of the present invention.

The management computer 200 is composed of a CPU 201, a main memory 202, a storage device 203, a management interface unit 204 and a bus 205. The CPU 201, the main memory 202, the storage device 203 and the management interface unit 204 are mutually coupled via the bus 205.

The main memory 202 stores programs read out and executed via the CPU 201. For example, the main memory 202 stores the program of a logical volume allocation optimizing program 211.

The storage device 203 can be an HDD (Hard Disk Drive) or an SSD (Solid State Drive), for example, for storing the functions and information in the main memory 202 and copying the information to the main memory 202 when the management computer 200 is started.

The management computer 200 is coupled to the management network 400 via the management interface unit 204. The management interface unit 204 writes the information received via the management network 400 to the main memory 202, and transmits the information read from the main memory 202 via the management network 400.

FIG. 4 is a view illustrating in detail an example of the configuration of the storage system 100 shown in FIG. 1 according to the preferred embodiment of the present invention.

The storage system 100 is composed of a controller chassis 110 and drive chassis 130.

The controller chassis 110 includes a storage controller 111. The storage controller 111 is composed of a CPU 112, a main memory 113, a cache memory 114, a host interface unit 115, a management interface unit 116, a drive interface unit 117 and a bus 118.

The CPU 112, the main memory 113, the cache memory 114, the host interface unit 115, the management interface unit 116 and the drive interface unit 117 are coupled via the bus 118.

The host interface unit 115 is an interface unit coupled to the host computer 300 via the storage area network 410 through which the host computer 300 performs input and output of data.

The management interface unit 116 is an interface unit used by the management computer 200 to perform storage management, which is coupled to the management computer 200 via the management network 400.

The CPU 112 is a processor for executing the programs stored in the main memory 113, and controlling the respective units within the storage system 100. For example, the CPU 112 can control the input and output processing of data to an HDD 131 or an SSD 132 described later allocated within the drive chassis 130 in response to the input and output of data requested from the host computer 300 via the host interface unit 115.

The main memory 113 stores management data and control data of the storage system 100. The cache memory 114 and the main memory 113 can be a volatile memory or a nonvolatile memory (such as a flash memory).

Further, the main memory stores various programs including an environment information acquisition program 125, a logical volume allocation destination determination program 126 and a logical volume allocation program 127, and various information including a configuration information 121, a operation information 122, a drive chassis environment information 123 and a logical volume move plan information 124, wherein these programs stored in the main memory 113 are executed via the CPU 112. The respective programs and information stored in the main memory will be described in detail later.

The cache memory 114 temporarily stores the write data to be written to the drive unit or the read data read from the drive unit.

The drive interface unit 117 is an interface unit coupled to the drive chassis 130 through which the storage controller 111 performs input and output of data.

Further, the above-illustrated components can be duplexed in order to enhance availability.

The drive chassis 130 comprises one or more drive units, an inlet air temperature sensor 133, an internal temperature sensor 134, a cooling fan 135 and a local CPU 136.

The drive unit can be, for example, an HDD 131 or an SSD 132, which stores the programs and information stored in the main memory 113 and copies the data to the main memory 113 when the storage system 100 is started.

In embodiment 1, the storage system 100 includes four drive chassis 130, wherein two of the drive chassis 130 mount HDDs 131 only and the remaining two drive chassis 130 mount SSDs 132 only.

The storage system 100 allocates two or more drive units to an RG (RAID (Redundant Arrays of Inexpensive Disks) Group) which is a group of disks having a redundant configuration. The storage system 100 defines all or a portion of the storage area that the drive units included in the RG has as a logical volume, and provides the same as a virtual (or a logical) storage device to the host computer 300.

The inlet air temperature sensor 133 is a sensor for measuring the inlet air temperature of the respective drive chassis 130. By having the environment information acquisition program 125 described later access the local CPU 136, the measured inlet air temperature data is provided to the storage controller 111.

The internal temperature sensor 134 is a sensor for measuring the internal temperature of the respective drive chassis 130.

The cooling fan 135 is a device for cooling the interior of the respective drive chassis 130. In FIG. 4, the target to be cooled by the cooling fan 135 is the whole drive chassis 130 having the cooling fan disposed therein. There may be multiple cooling fans 135 disposed in a single drive chassis, and each cooling fan 135 can have components (mainly drive units) or an area within the chassis determined as the target to be cooled thereby. Although not shown in FIG. 4, a cooling fan can be disposed in the controller chassis 110.

The local CPU 136 controls the rotation speed of the cooling fans 135 via PI control or PID control based on the value of the internal temperature acquired from the internal temperature sensor 134, so as to maintain the internal temperature to approximate a target internal temperature.

The local CPU 136 acquires the inlet air temperature information from the inlet air temperature sensor 133 periodically, such as once every second. If the inlet air temperature falls out of the target range of the operation guarantee temperature, a warning is output to the storage controller 111 and notified to the storage administrator.

Further, the local CPU 136 outputs the latest inlet air temperature or the cooling fan rotation speed to the storage controller 111 in response to the requests from the environment information acquisition program 125.

The drive configuration management table 500 shown in FIG. 5 constitutes a portion of the configuration information 121 of FIG. 4, which stores information related to the drive chassis 130 to which a certain drive unit is mounted, the location of the drive within the drive chassis 130, and the RG to which the drive unit belongs.

RAID is a technique for collectively managing multiple drive units as a single drive unit. By constituting a RAID configuration, data can be written in a dispersed manner to the multiple drive units constituting the RAID, by which the read/write speed of data can be enhanced. Further, since an error correction information for recovering data is written into the drive unit constituting the RAID during writing of data, data can be recovered even if a portion of the drive units constituting the RAID fails.

RG refers to a group of drive units constituting the RAID.

According to the drive configuration management table 500 of FIG. 5, a drive name 501 refers to the name of the drive units. A drive chassis name 502 refers to the name of the drive chassis 130 to which the drive unit is mounted. A drive location 503 refers to the location number within the drive chassis 130 to which the drive unit is mounted. For example, drives are arranged within a single drive chassis 01 from the left in the following order; drive 01, 02, 03 and 04. An RG name 504 refers to the name of the RG to which the drive unit belongs. For example, it is shown that RG01 is composed of multiple drives, which are drives 1 through 4.

The RG configuration management table 600 shown in FIG. 6 constitutes a portion of the configuration information 121 of FIG. 4, and shows information related to the RG configuration.

An RG name 601 refers to the name of the RG. A drive type 602 refers to the type of the drive units constituting the RG. A number of drives 603 refers to the number of drive units constituting the RG. A RAID level 604 refers to the RAID level of the RG. For example, if the drive number 603 is 4 and the RAID level 604 is RAID5, the RAID configuration is 3D+1P. A configuration drive 605 shows the drive chassis number to which the drive unit constituting the RG is located and the drive location number within the drive chassis 130. A total capacity 606 is the maximum user data capacity capable of being stored in the RG. For example, in RAID level 5, the capacity of the parity is not included in the total capacity. A limit operation amount 607 refers to a limit operation amount of the RG. A limit operation amount of the RG refers to a limit of the operation amount capable of maintaining the normal performance of the RG. If commands are output to the RG exceeding the limit operation amount, the response time to the command will be longer compared to when the limit operation amount is not exceeded. The unit of limit operation amount 607 is the number of accesses per second to the RG. According to embodiment 1, a limit operation amount is set for each RG, but the limit operation amount can also be set for each drive chassis 130.

A power increase function 608 is an expression of the function for computing the amount of increase of power consumption when the operation amount of the RG is x. Each RG is composed of drive units such as HDDs and SSDs having an interface for a FC (Fibre Channel), HDDs and SSDs having an interface for a SAS (Serial Attached SCSI), or HDDs and SSDs having an interface for SATA (Serial Advanced Technology Attachment). The power consumption of the RG with respect to the operation amount differs according to the types of the drive units, such as the HDD having an FC interface, the HDD having a SATA interface, and the SSD. The respective functions can be determined based on the types of the drive units included in each RG, or can be computed based on measurement in advance for each drive chassis 130. In embodiment 1, for simplicity, the power increase function is set as a linear function of the operation amount of the RG, x, but it is not limited thereto. Further according to embodiment 1, the power increase with respect to the operation amount of each RG is computed using the function, but the method for determining the power increase is not limited thereto, and the power increase can be determined through use of a table or the like.

The RG operation management table 700 of FIG. 7 constitutes a portion of the operation information 122 of FIG. 4, and stores information related to the operation of the RG.

An RG name 701 shows the name of the RG. A logical volume number 702 shows the number of logical volumes allocated to the RG. A free space 703 shows the free space of the RG. An operation amount history 704 shows the history of the operation amount of the RG. The unit of the operation amount history 704 shows the number of accesses per second to the RG. The operation amount shown in the operation amount history 704 can be an average operation amount per day, or a momentary operation amount at a certain time.

The logical volume configuration management table 800 of FIG. 8 constitutes a portion of the configuration information 121 of FIG. 4, and stores information related to the capacity of the logical volume, the name of the RG to which the logical volume is allocated, the possibility of movement of the logical volume, and so on. The logical volume is formed by dividing a single RG so that multiple host computers can access the RG.

A logical volume name 801 shows the name of the logical volume. A capacity 802 shows the capacity of the logical volume. An RG name 803 shows the name of the RG to which the logical volume is allocated. A move possibility 804 shows whether the logical volume can be moved to a different RG or not, which is designated by the storage administrator when the logical volume is created. In case of “movable”, the logical volume can be moved to a different RG, and in case of “immovable”, the logical volume cannot be moved to a different RG. A connection source 805 shows the host computer 300 accessing the logical volume.

The logical volume operation management table 900 of FIG. 9 constitutes a portion of the operation information 122 of FIG. 4, and stores information related to the operation history of the logical volume.

A logical volume name 901 shows the name of the logical volume. An operation amount history 902 shows the history of the operation amount of the logical volume. The unit of the operation amount history 902 is the number of accesses per second to the logical volume. The operation amount shown in the operation amount history 902 can be, for example, an average operation amount per day or a momentary operation amount at a certain point of time.

The drive chassis environment management table 1000 of FIG. 10 corresponds to the drive chassis environment information 123 of FIG. 4.

A drive chassis name 1001 shows the name of the drive chassis 130. A monitored inlet air temperature value 1002 stores the measured value from the inlet air temperature sensor of each drive chassis 130 acquired by the local CPU 136 through communication with the local CPU 136. This monitored inlet air temperature value is acquired and updated periodically, such as every 10 seconds. A control target internal temperature 1003 has a target temperature value set according to the types or number of drive units mounted in the drive chassis 130. For example, the control target internal temperature of the drive chassis 130 having only HDDs mounted thereto is 40° C., and the control target internal temperature of the drive chassis 130 having only SSDs mounted thereto is 25° C. A chassis base power 1004 is set to a value corresponding to the types and numbers of the drive units disposed in the drive chassis 130. A fan rotation speed 1005 stores the value of the fan rotation speed of each drive chassis 130 acquired by the local CPU 136 through communication with the local CPU 136. The value of the fan rotation speed is acquired and updated periodically, such as every 10 seconds.

The logical volume move plan table 1100 of FIG. 11 corresponds to the logical volume move plan information 124 of FIG. 4.

A reallocation priority order 1101 shows the order of priority in a reallocation process of the logical volumes. A logical volume name 1102 shows the name of the logical volume. A move source RG 1103 shows the name of the move source RG of the logical volume. A move destination RG 1104 shows the name of the move destination RG of the logical volume. It shows that there is a plan to move data within the logical volume from a move source RG to a move destination RG indicated on the same row of the table. In the table shown in FIG. 11, a plan to move the data within the logical volume is created in logical volume units, but it is also possible to create a plan to move the data in drive chassis units or RG units.

Now, a process flow of the logical volume allocation optimizing program 211 performed by the storage system to determine the allocation destination of data within the logical volumes and to allocate logical volumes with the aim to cut down power consumption caused by the cooling fans in the overall storage system according to the present invention will be described.

In embodiment 1, the CPU 201 of the management computer 200 executes the logical volume allocation optimizing program 211 based on the request from the storage administrator to initially allocate a logical volume to the storage system.

Now, based on the initial allocation request of the logical volume output from the storage administrator, the intended purpose of the logical volumes being allocated (such as a database), the types of drives and the RG configuration are designated by the storage administrator.

The process performed by the logical volume allocation optimizing program 211 will be described with reference to the process flow of FIG. 12.

At first, in step S1201, the logical volume allocation optimizing program 211 calls the environment information acquisition program 125 to collect the inlet air temperature and fan rotation speed of each drive chassis 130, and updates the drive chassis environment management table 1000 of FIG. 10.

Next, in step S1202, a logical volume allocation destination determination program 126 is executed.

FIG. 13 is a view showing the details of the process flow of the logical volume allocation destination determination program 126.

In step S1301, the amount of power increase of the RG by the operation of the logical volume is computed. The amount of power increase is computed based on the intended purpose of the logical volume, the drive type and the RG configuration designated by the storage administrator. In other words, the amount of operation assumed based on the intended purpose of the logical volume is set, and based on the drive type and the RG configuration, the amount of power increase is computed using the power increase function 608 of the RG configuration management table 600 illustrated in FIG. 6.

The assumed operation amount of the logical volume can be set automatically by the storage system based on the intended purpose of the logical volume, or can be designated in advance by the storage administrator.

In step S1302, with respect to the initially allocated logical volume, the amount of power increase in fan of the drive chassis 130 based on the operation of the logical volume is computed for each drive chassis 130. The relationship between the drive chassis power and the fan rotation speed before and after allocating the logical volume is represented by the following expressions (Expression 1) and (Expression 2), where chassis power P is set as a chassis base power 1004 in the drive chassis environment management table 1000, and amount of power increase ΔP of the chassis is set as the amount of power increase by the operation of the logical volume:

before allocating logical volume;

Q=P×t=c×p×S×t×(T1−T0) (Expression 1)

after allocating logical volume;

Q+ΔQ=(P+ΔP)×t=c×p×(S+ΔS)×t×(T1T0) (Expression 2)

where Q represents the amount of heat generation of chassis, ΔQ represents the increased amount of heat generation of chassis, P represents the chassis power, ΔP represents the increased amount of power of chassis, t represents the unit time, c represents the air specific heat, p represents the air density, S represents the fan rotation speed, T1 represents the target internal temperature, and T0 represents the inlet air temperature. The increased amount of fan rotation speed ΔS is represented by the following expression:

ΔS=ΔP/{c×ρ×(T1−T0)} (Expression 3)

The amount of increase in fan power ΔP_{F} is represented by the following expression with C as proportional constant:

ΔP_{F}=C×(S+ΔS)³−C×S³ (Expression 4)

based on which the amount of increase in fan power of the drive chassis 130 is computed.

In step S1303, the order of priority of the drive chassis 130 as the allocation destination of logical volumes is set in the order from the chassis having the smallest amount of increase in fan power.

In step S1304, the drive chassis 130 having the highest priority is selected. In determination step S1305, it is determined whether RGs having the same configuration exist within the selected drive chassis 130. If the values stored in the drive type 602, the number of drives 603 and the RAID level 604 in the RG configuration management table 600 are all the same, it is determined that the RGs have the same configuration. It is not necessary that the values stored in the total capacity 606 are the same. If there are RGs having the same configuration, the procedure advances to step S1306. If there are no RGs having the same configuration, the procedure advances to step S1309, where a drive chassis 130 having the next highest priority is selected.

In step S1306, the RG having the same configuration as the RG configuration designated by the storage administrator is selected as the RG candidate of the allocation destination of the logical volume.

In determination step S1307, it is confirmed using the free space 703 in the RG operation management table 700 whether there is enough free space for storing the logical volume to be allocated in the RG candidate of the allocation destination of the logical volume selected in step S1306. If there is an RG having such free space, the procedure advances to step S1308. If there is no RG having such free space, the procedure advances to step S1309, where a drive chassis 130 having the next highest priority is selected.

In step S1308, the RG having enough free space for storing the logical volume being allocated is selected as the RG candidate of the new allocation destination of the logical volume.

In determination step S1310, regarding the RG being the candidate of the allocation destination of the logical volume selected in step S1308, it is confirmed whether the operation amount of RG after allocating the logical volume is equal to or smaller than the limit operation amount of the RG. Actually, it is confirmed that the operation amount of the logical volume does not exceed the limit operation amount 607 in the RG configuration management table 600. If there is an RG where the limit operation amount is not exceeded, the procedure advances to step S1311. If there is no RG where the limit operation amount is not exceeded, the procedure advances to step S1309, where a drive chassis 130 having the next highest priority is selected.

Step S1311 selects the drive chassis 130 and the RG being the allocation destination of the logical volume.

Next, in step S1203 of FIG. 12, the CPU 112 executes a logical volume move program 127, according to which the logical volume is created in the RG of the drive chassis 130 selected in step S1311, and the logical volume is registered in the logical volume configuration management table 800 of FIG. 8.

Based on embodiment 1, since the new logical volume is allocated to the drive chassis where the amount of power increase caused by the rotation of the cooling fan is minimum, the increase of power and the increase of noise caused by the operation of the logical volume can be suppressed.

### Embodiment 2

### <Additional Allocation of Logical Volume>

Now, a second embodiment of the present invention for additionally allocating a logical volume to a storage system composed of multiple drive chassis and having a logical volume already allocated thereto will be described, wherein the amount of increase of power consumption of the fan of the drive chassis due to the operation of the logical volume being added thereto is computed, based on which a drive chassis being the allocation destination of the logical volume is selected so that the amount of increase in fan power within the overall storage system is minimized, and the logical volume is additionally allocated thereto.

In embodiment 2, the CPU 201 of the management computer 200 executes the logical volume allocation optimizing program 211 based on the request output from the storage administrator to additionally allocate a logical volume to the storage system 100.

The step S1201 of the logical volume allocation optimizing program 211 illustrated in FIG. 12 is the same as embodiment 1, so the description thereof is omitted.

Further, the process flow of the logical volume allocation destination determination program 126 executed in step S1202 is the same as embodiment 1, except for step S1302, determination step S1307 and determination step S1310 of FIG. 13.

In step S1302, regarding the logical volume being additionally allocated, the amount of increase in fan power ΔP_{F} of the drive chassis 130 based on the operation of the logical volume is computed for each drive chassis 130. Here, the chassis power P in (Expression 1) and (Expression 2) represents the power having added the amount of power increase by the operation of the existing logical volume to the chassis base power.

In determination step S1307, it is confirmed based on the RG operation management table 700 whether there is enough free space for storing the logical volume being allocated in the RG candidate of the allocation destination of the logical volume selected in step S1306. Actually, it is confirmed that the total capacity of the logical volume being added and the logical volume already allocated to the RG candidate of the allocation destination does not exceed the total capacity 606 of the RG configuration management table 600. If an RG having such free space exists, the procedure advances to step S1308. If there is no RG having such free space, the procedure advances to step S1309, where a drive chassis 130 having the next highest priority is selected.

In determination step S1310, regarding the RG being the candidate of allocation destination of the logical volume selected in step S1308, it is confirmed whether the operation amount of RG after allocating the logical volume is equal to or smaller than the limit operation amount of the RG. Actually, it is confirmed that the total operation amount of the logical volume being added and the logical volume already allocated to the RG being the candidate of allocation destination does not exceed the limit operation amount 607 in the RG configuration management table 600. If there is an RG where the limit operation amount is not exceeded, the procedure advances to step S1311. If there is no RG where the limit operation amount is not exceeded, the procedure advances to step S1309, where a drive chassis 130 having the next highest priority is selected.

The step S1203 of FIG. 12 executed after terminating the process of the logical volume allocation destination determination program 126 is the same as above, so the description thereof is omitted.

According to embodiment 2, by allocating the logical volume being added to a drive chassis where the amount of increase in fan power ΔP_{F} caused by the rotation of the cooling fan becomes minimum, it becomes possible to suppress the increase of power and the increase of noise by the operation of the logical volume being added.

### Embodiment 3

### <Reallocation of Logical Volume>

Now, a third embodiment of the present invention is illustrated, wherein in a normal operation of a storage system composed of multiple drive chassis and having multiple logical volumes already allocated thereto, the amount of increase of power consumption of the fan in the drive chassis due to the operation of each logical volume is computed, and the selection of drive chassis being the reallocation destination of each logical volume is performed so that the amount of increase in fan power in the overall storage system becomes minimum, and the logical volume is reallocated accordingly.

According to embodiment 3, the CPU 201 of the management computer 200 executes the logical volume allocation optimizing program 211, at any one of the following timings; periodical timings (such as every six months), a voluntary timing when a request from the storage administrator is output, or a timing when a change in inlet air temperature distribution exceeds a given quantity.

The step S1201 of the logical volume allocation optimizing program 211 illustrated in FIG. 12 is the same as embodiment 1, so the description thereof is omitted.

Now, the details of the process flow by the logical volume allocation destination determination program 126 executed in the step 1202 will be described with reference to FIG. 14.

In step S1401, the amount of power increase of the RG by the operation of the logical volume is computed for the logical volume having the move possibility 804 set to “movable” in the logical volume configuration management table 800. Actually, the amount of power increase is computed using the operation amount history 902 of the logical volume and the power increase function 608 of the RG to which the logical volume belongs.

In step S1402, the order of priority of the logical volume is set in the order starting from the logical volume having the greatest increase in the amount of power of the RG by the operation of the logical volume, the information of which is stored in the logical volume name 1102 and the move source RG 1103 of the logical volume move plan table 1100.

In step S1403, the logical volume having the highest priority is selected.

In step S1404, with respect to the selected logical volume, the amount of increase in fan power ΔP_{F} of the drive chassis 130 by the operation of the logical volume is computed for each drive chassis 130. Here, the chassis power P in (Expression 1) and (Expression 2) represents the power having added to the chassis base power the amount of power increase by the operation of the immovable logical volume or the logical volume where the same drive chassis is selected as the reallocation destination.

In step S1405, the order of priority of the drive chassis 130 as the reallocation destination of the logical volume is set in the order starting from the chassis having the smallest amount of increase in fan power ΔP_{F}.

In step S1406, the drive chassis 130 having the highest priority is selected.

In determination step S1407, it is determined whether an RG having the same configuration as the RG to which the selected logical volume is allocated exists in the drive chassis 130 selected in step S1406. If the values stored in the drive type 602, the number of drives 603 and the RAID level 604 are all the same in the RG configuration management table 600, it is determined that the RGs have the same configuration. It is not necessary that the values stored in the total capacity 606 are the same. If there are RGs having the same configuration, the procedure advances to step S1408. If there are no RGs having the same configuration, the procedure advances to step S1409, where a drive chassis 130 having the next highest priority is selected.

In step S1408, the RG having the same configuration as the RG to which the selected logical volume is allocated is selected as the candidate of the RG being the reallocation destination of the logical volume.

In determination step S1410, it is confirmed using the RG operation management table 700 whether there is enough free space for storing the selected logical volume in the RG being the candidate of the reallocation destination of the logical volume selected in step S1408. Actually, it is confirmed that the total capacity of the logical volume 802, the immovable logical volume in the candidate reallocation destination RG and the logical volume whose reallocation destination is already selected to the same RG does not exceed the total capacity 606 in the RG configuration management table 600. If there is an RG having such free space, the procedure advances to step S1411. If there is no RG having enough free space, the procedure advances to step S1409, where a drive chassis 130 having the next highest priority is selected.

In step S1411, the RG having such free space is selected as the RG being the new reallocation destination candidate of the logical volume.

In determination step S1412, regarding the RG being the candidate of reallocation destination of the logical volume selected in step S1411, is confirmed whether the operation amount of RG after allocating the logical volume is equal to or smaller than the limit operation amount of the RG. Actually, it is confirmed that the total operation amount of the logical volume, the immovable logical volume in the candidate reallocation destination RG and the logical volume whose reallocation destination is already selected to the same RG does not exceed the limit operation amount 607 in the RG configuration management table 600. If there is an RG where the operation is equal to or smaller than the limit operation amount, the procedure advances to step S1413. If there is no RG where the operation is equal to or smaller than the limit operation amount, the procedure advances to step S1409, where a drive chassis 130 having the next highest priority is selected.

In step S1413, the drive chassis 130 and the RG being the destination of movement of the logical volume is selected and stored in the move destination RG 1104 of the logical volume move plan table 1100.

If the reallocation destination of all movable logical volumes is not determined in the determination step S1414, the procedure advances to step S 1415, where the logical volume having the next highest priority is selected.

Next, in step S1203 of FIG. 12, the CPU 112 executes the logical volume allocation program 127, based on which the logical volume being the target of reallocation is moved. The logical volume allocation program 127 executes the movement of the logical volume based on the logical volume move plan table 1100. In the example of FIG. 11, the logical volume LU01 is moved from RG01 to RG05, and the logical volume LU02 is moved from RG02 to RG04. Lastly, the RG name 803 in the logical volume configuration management table 800 of FIG. 8 is updated.

Based on embodiment 3, by reallocating the logical volume to a drive chassis where the amount of power increase caused by the rotation of the cooling fan becomes minimum, the increase of power consumption and the increase of noise due to the rotation of the cooling fan caused by the operation of the logical volume can be suppressed.

As have been illustrated in embodiments 1 through 3, it becomes possible to suppress the increase of power consumption and the increase of noise due to the rotation of the cooling fan 135 in the drive chassis 130, by specifically controlling the movement of the logical volume based on the inlet air temperature difference and the operation amount distribution among drive chassis 130 in the configuration described above.

According to embodiments 1 through 3, the logical volume allocation optimizing program 211 started by the request from the storage administrator is stored in the management computer 200, and the other programs including the logical volume allocation program 127 are stored in the storage system 100, but the present invention is not limited to such example. In other words, it is possible to have all the programs stored in the management computer 200 or have all the programs stored in the storage system 100.

Further according to embodiments 1 through 3, the allocation of logical volumes is optimized targeting a single storage system, but if the management computer manages multiple storage systems, the same effects as embodiments 1 through 3 can be achieved by executing new allocation, additional allocation and reallocation of the logical volumes targeting the multiple storage systems. That is, when executing new allocation or additional allocation of the logical volumes, the allocation destination of logical volumes is selected from all the drive chassis belonging to the multiple storage systems, and when executing reallocation of the logical volumes, the reallocation processing of the logical volumes is performed among all the drive chassis belonging to the multiple storage systems, according to which the increase of power and increase of noise due to the rotation of the cooling fans based on the operation of the logical volumes in the overall multiple storage systems can be suppressed.

### Reference Signs List

100: Storage system

200: Management computer

300: Host computer

400: Management network

410: Storage area network

110: Controller chassis

130: Drive chassis

133: Inlet air temperature sensor

134: Internal temperature sensor

135: Cooling fan

1. A method for allocating a logical volume in a storage system having a plurality of drive chassis including one or more drive units and one or more cooling fans in each drive chassis, in which all or a portion of a storage area included in the drive unit is set as a logical volume, the method comprising:
computing an amount of power increase of the cooling fan by an operation of the logical volume;
selecting a drive chassis as an allocation destination of the logical volume, the order of priority corresponding to an order of the drive chassis having the smallest amount of power increase; and
allocating the logical volume to the drive chassis selected with priority.

2. The method for allocating a logical volume according to claim 1, wherein
two or more of the drive units is allocated to form a RAID group; and
all or a portion of the storage area of the drive units included in the RAID group is set as a logical volume.

3. The method for allocating a logical volume according to claim 2, wherein
when the RAID group allocated to the selected drive chassis corresponds to a designated RAID group configuration, the RAID group is selected as a candidate of the allocation destination of the logical volume.

4. The method for allocating a logical volume according to claim 3, wherein
when the selected RAID group has a free space capable of storing the logical volume to be allocated, the RAID group is selected as a candidate of the allocation destination of the logical volume.

5. The method for allocating a logical volume according to claim 4, wherein
when an operation amount by the logical volume to be allocated is equal to or smaller than a limit operation amount of the selected RAID group, the RAID group is selected as the allocation destination of the logical volume.

6. The method for allocating a logical volume according to claim 1, wherein
when a new logical volume to be set as an allocation target is added to the storage system already having a logical volume allocated thereto, the target of computing the amount of power increase of the cooling fan is the new logical volume.

7. The method for allocating a logical volume according to claim 1, wherein
there are a plurality of said storage systems, and the allocation destination of the logical volume is selected from all drive chassis belonging to the plurality of storage systems.

8. A method for reallocating a logical volume in a storage system having a plurality of drive chassis including one or more drive units and one or more cooling fans in each drive chassis, in which all or a portion of a storage area included in the drive unit is set as a logical volume, the storage system having one or more logical volumes allocated thereto, the method comprising:
setting a first order of priority corresponding to an order of the logical volume having a greatest amount of power increase by an operation of the logical volume;
setting a second order of priority corresponding to an order of the drive chassis having a smallest amount of power increase of the cooling fan; and
allocating, in order from the logical volume having the highest first order of priority to the drive chassis having the highest second order of priority.

9. The method for reallocating a logical volume according to claim 8, the method comprising:
constituting a RAID group by allocating two or more of the drive units; and
setting all or a portion of the storage area of the drive unit included in the RAID group as a logical volume.

10. The method for reallocating a logical volume according to claim 9, the method comprising:
computing the amount of power increase by the operation of the logical volume based on an operation amount history of the logical volume and a function or a table of the amount of power increase of the RAID group to which the logical volume belongs.

11. The method for reallocating a logical volume according to claim 10, the method comprising:
when the RAID group constituted in the drive chassis selected for reallocation corresponds to a RAID group configuration to which the logical volume selected for reallocation is allocated, selecting the RAID group as a candidate of a reallocation destination of the logical volume.

12. The method for reallocating a logical volume according to claim 11, the method comprising:
when the RAID group being selected has a free space for storing the logical volume to be allocated thereto, the selected RAID group is selected as a candidate of the reallocation destination of the logical volume.

13. The method for reallocating a logical volume according to claim 12, the method comprising:
when an operation amount by the logical volume being allocated is equal to or smaller than a limit operation amount of the RAID group being selected, the RAID group is selected as the reallocation destination of the logical volume.

14. The method for reallocating a logical volume according to claim 8, wherein
there are a plurality of storage systems, and the method comprises reallocating the logical volume among all drive chassis belonging to the plurality of storage systems.
